(19) United States
(12) Patent Application Publication
(10) Pub. No.: US 2006/0212187 A1
(43) Pub. Date: Sep. 21, 2006

(54) Scheduler and method for managing unpredictable local trains

(76) Inventors: Mitchell Scott Wills, Melbourne, FL (US); Joseph Wesley Philp, Indialantic, FL (US); Joanne Maceo, Rockledge, FL (US); Joel Kickbusch, Rockledge, FL (US)

Correspondence Address: DUANE MORRIS LLP, Suite 700, 1667 K Street, N.W., Washington, DC, 20006, US

(21) Appl. No.: 11/342,856

(22) Filed: Jan. 31, 2006

Related U.S. Application Data
(63) Continuation-in-part of application No. 10/785,059, filed on Feb. 25, 2004.
(60) Provisional application No. 60/449,849, filed on Feb. 27, 2003.

(51) Int. Cl. G01C 21/00

(52) U.S. Cl. 701/19; 701/200

(57) ABSTRACT

A scheduling system and method for moving plural objects through a multipath system described as a freight railway scheduling system. The scheduling system utilizes a cost reactive resource scheduler to minimize resource exception while at the same time minimizing the global costs associated with the solution. The achievable movement plan can be used to assist in the control of, or to automatically control, the movement of trains through the system, and is particularly useful in managing the unpredictable movement of local industry trains.

### RELATED APPLICATIONS

This application is a continuation in part of application Ser. No. 10/785,059 filed Feb. 25, 2004, claiming the benefit of U.S. Provisional Application 60/449,849 filed on Feb. 27, 2003.

This application is also one of the below listed applications being concurrently filed:

GEH01 00167 application Ser. No. ______ entitled “Method And Apparatus For Optimizing Maintenance Of Right Of Way”’

GEH01 00168 application Ser. No. ______ entitled “Method And Apparatus For Coordinating Railway Line-Of-Road and Yard Planners”;

GEH01 00169 application Ser. No. ______ entitled “Method And Apparatus For Selectively Disabling Train Location Reports”;

GEH01 00170 application Ser. No. ______ entitled “Method And Apparatus For Automatic Selection Of Train Activity Locations”;

GEH01 00171 application Ser. No. ______ entitled “Method And Apparatus For Congestion Management”;

GEH01 00172 application Ser. No. ______ entitled Method And Apparatus For Automatic Selection Of Alternative Routing Through Congested Areas Using Congestion Prediction Metrics”; and

GEH01 00173 application Ser. No. ______ entitled “Method and Apparatus for Estimating Train Location”.

The disclosure of each of the above referenced applications including those concurrently filed herewith is hereby incorporated herein by reference.

### BACKGROUND OF THE INVENTION

The present invention relates to the scheduling of movement of plural units through a complex movement defining system, and in the embodiment disclosed, to the scheduling of the movement of freight trains over a railroad system, particularly the managing the unpredictable movement of local industry trains.

Systems and methods for scheduling the movement of trains over a rail network have been described in U.S. Pat. Nos. 6,154,735, 5,794,172, and 5,623,413, the disclosure of which is hereby incorporated by reference.

As disclosed in the referenced patents and applications, the complete disclosure of which is hereby incorporated herein by reference, railroads consist of three primary components (1) a rail infrastructure, including track, switches, a communications system and a control system; (2) rolling stock, including locomotives and cars; and, (3) personnel (or crew) that operate and maintain the railway. Generally, each of these components are employed by the use of a high level schedule which assigns people, locomotives, and cars to the various sections of track and allows them to move over that track in a manner that avoids collisions and permits the railway system to deliver goods to various destinations.

As disclosed in applicant's prior applications, a precision control system includes the use of an optimizing scheduler that will schedule all aspects of the rail system, taking into account the laws of physics, the policies of the railroad, the work rules of the personnel, the actual contractual terms of the contracts to the various customers and any boundary conditions or constraints which govern the possible solution or schedule such as passenger traffic, hours of operation of some of the facilities, track maintenance, work rules, etc. The combination of boundary conditions together with a figure of merit for each activity will result in a schedule which maximizes some figure of merit such as overall system cost.

As disclosed in the referenced applications, and upon determining a schedule, a movement plan may be created using the very fine grain structure necessary to actually control the movement of the train. Such fine grain structure may include assignment of personnel by name as well as the assignment of specific locomotives by number and may include the determination of the precise time or distance over time for the movement of the trains across the rail network and all the details of train handling, power levels, curves, grades, track topography, wind and weather conditions. This movement plan may be used to guide the manual dispatching of trains and controlling of track forces, or provided to the locomotives so that it can be implemented by the engineer or automatically by switchable actuation on the locomotive.

The planning system is hierarchical in nature in which the problem is abstracted to a relatively high level for the initial optimization process, and then the resulting course solution is mapped to a less abstract lower level for further optimization. Statistical processing is used at all levels to minimize the total computational load, making the overall process computationally feasible to implement. An expert system is used as a manager over these processes, and the expert system is also the tool by which various boundary conditions and constraints for the solution set are established. The use of an expert system in this capacity permits the user to supply the rules to be placed in the solution process.

Generally, a dispatcher's view of the controlled railroad territory can be considered myopic. Dispatchers view and process information only within their own control territories and have little or no insight into the operation of adjoining territories, or the railroad network as a whole. Current dispatch systems simply implement controls as a result of the individual dispatcher's decisions on small portions of the railroad network and the dispatchers are expected to resolve conflicts between movements of objects on the track (e.g. trains, maintenance vehicles, survey vehicles, etc.) and the available track resource limitations (e.g. limited number of tracks, tracks out of service, consideration of safety of maintenance crews near active tracks) as they occur, with little advanced insight or warning.

As disclosed in the referenced applications, anomalies large and small are encountered in the planed movement are continuously monitoring for rescheduling with the aid of the system. However, because unscheduled activities are not included in the movement plan, local industry trains are not treated as anomalies to the plan. Thus, the system is not available to the dispatcher for the normal anomaly resolution or exception handling process at the various levels of the hierarchical planning system in time sequence until the anomaly is fully resolved.

Local industry trains are problematical. The movement of local industry trains is generally not included in the movement plan because of the unpredictable nature thereof, e.g., trains that travel from a yard or local spur a short distance over a main track to a spur associated with a manufacturing facility for the delivery of raw materials to the manufacturing facility or for the delivery of fuel to a power plant. This may require that an order that cars be “set out“, or “picked up”, or that loaded cars may “spotted” for future orders. Typically, this puts the dispatcher in a position where he must on an ad hoc basis exercise manual control to accommodate the presence of the local industry train on the main track.

For example, if the railroad submits a request for local train movement to the dispatcher, the dispatcher is required to facilitate the movement of the local industry train by either avoiding all activity previously scheduled. The dispatcher typically does this without providing input to the movement planners that planned the movement of trains through the area.

The dispatcher's alternative has been to alter the predetermined movement plan by the insertion of constraints into the plan, e.g., a specific section of track is no longer available during certain hours for the movement of trains by the planner. If the dispatcher's ad hoc scheduling of local industry trains interrupts the execution of the movement plan, the effect on the movement plan is generally not realized until the movement has begun. Once the impact of the unscheduled movement is appreciated and accommodated by the movement plan, further impacts, possibly even more detrimental to the movement plan, may have already occurred.

As disclosed in the referenced applications, the movement of trains may be improved by increasing the communications between the dispatcher and the computer planning system, by shifting responsibilities traditionally performed by the dispatcher planning system, and by the use of interactive displays to facilitate the transfer of information to and feedback from the dispatcher from the planning system. This is accomplished by providing an interface between the scheduling system and the dispatching system.

In the past, the dispatcher would receive requests for movement of a local industry train, typically by radio, add the request to his activity list, and work his way through the requested activity list by the scheduling of local resources on an ad hoc basis without use of the scheduling system.

In the present system, requested activities are received electronically and maintained in an electronic queue in the dispatching system without the assignment of any resources thereto as an “unassigned activity”. The dispatcher works his way through the activity list by selecting an unassigned activity and assigning locally available resources to the activity. The assignment of resources to an activity promotes that activity to an “assigned activity” and both the activity and the resources are electronically communicated to the scheduling computer for integration into the plan. The use of the scheduler to schedule the movement of local industry trains, albeit on short notice, frees the dispatcher to work on the selection of the next unassigned activity from among those on the unassigned activity list.

While the referenced applications have particular utility in freight railway systems, the environment may be viewed as a transportation system in which the variables are solved simultaneously rather than sequentially to achieve near optimality. In the freight railway system environment, the present invention relates to improved methods of scheduling the use of railway track and other facilities local by industry trains and for cost effective management of the interaction of local industry trains on the trains moving through the multitrack rail delivery system.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is a simplified pictorial representation of one embodiment of the present invention for use with a rail network divided into control areas.

FIG. 2 is a simplified functional block diagram of the automated dispatcher of FIG. 1.

FIG. 3 is a pictorial view of one embodiment of an interactive computer screen by which the dispatcher adds an unplanned assigned activity to the movement plan.

### DETAILED DESCRIPTION

As disclosed in the referenced applications, the efficiency of dispatching local industry trains over a network rail system is increased by the more efficient utilization of the dispatcher to provided information to supply information as soon as possible into the movement planning process to facilitate the automatic execution of optimum plans and routine dispatcher functions.

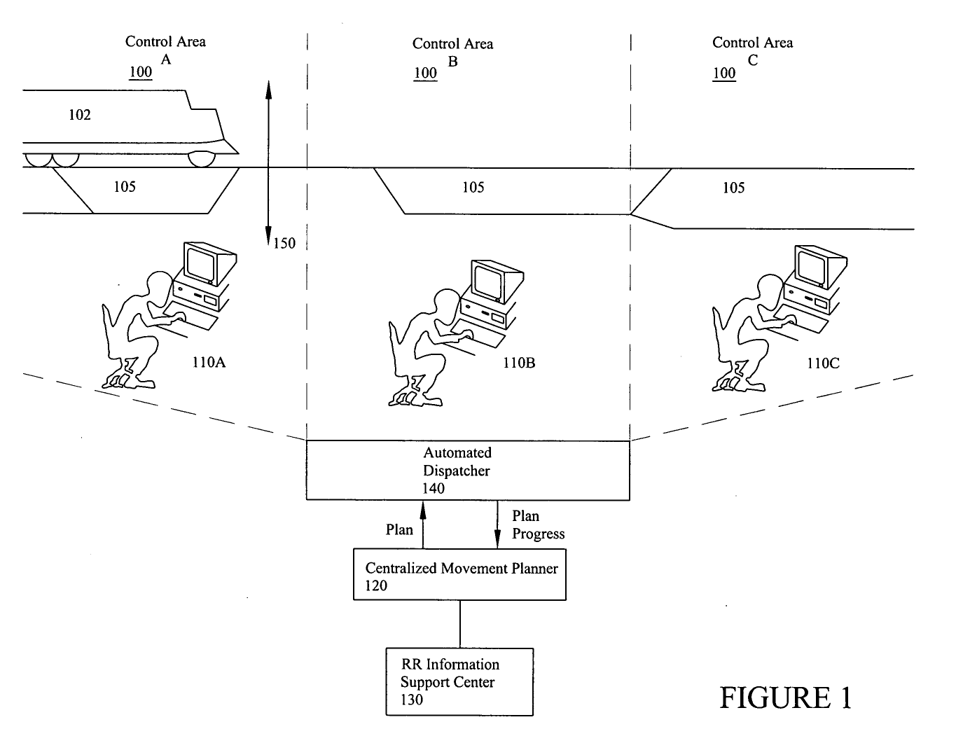

FIG. 1 illustrates one embodiment. The global rail network 105 can be divided into one or more control areas 100 (100A-100C), each of which has a dispatcher 110 (110A-110C) assigned to manage the movement of trains (102) through his respective control area 100. A centralized movement planner 120 provides a network based movement plan for the global rail network 105 based on input received from the railroad information support center 130. The railroad information support center 130 provides information related to the track resources and other information suitable to plan the use of the resources. Suitable information may include origin and destination for a train as well as activity locations and key waypoints on the trains' route. It may also include target departure and arrival times for origin and destination as well as key intermediate waypoints. It may also provide default consist data to be used for preliminary planning until more specific data is available and a default cost function developed for each train.

Centralized movement planner 120 generates a movement plan for the resources in the track network 105 and provides the plan to the automated dispatcher 140. Movement planner 120 may also received updates on the execution of the movement plan from automated dispatcher 140 and can update the current movement plan. Automated dispatcher 140 provides each of the dispatchers 110 with the movement plan to manage the train resources in their respective control areas 100.

The automated dispatcher 140 can be implemented using computer usable medium having a computer readable code executed by special purpose or general purpose computers. The automated dispatcher 140 communicates with trains 102 on the network of track via a suitable communication link 150, such as a cellular telephone, satellite or wayside signaling.

Even in this new paradigm, some of the dispatcher's duties will remain the same, however, the duties will then be in support of an optimized plan, rather than directed to detailed hands-on implementation of a plan. The dispatcher will continue to issue or approve issuance of movement authorities and track restrictions, schedule maintenance of way activities and communicate with train crews, yard managers and other railroad personnel. But, all of these activities will be consistent with an optimized operating plan for the railroad. While the dispatcher will rely on the movement planner to solve the complex problem of optimizing movement of trains, the dispatcher will be actively involved in entering the necessary data required to maintain an optimized plan and identify exceptions to the plan.

Prior movement planners typically did not receive information regarding the movement of local industry trains, and thus the movement planner could only provide retrospective relief for such movement after the delay had already been encountered, if at all. By providing earlier notification of a prospective movement, the movement planner can consider the prospective movement and reduce the impact thereof on the remainder of the movement plan, adjusting the movement of other trains accordingly.

As disclosed in the referenced applications, enhanced planning is facilitated by automatically supplying the movement planner 120 with information from the railroad information support center 130 which associates train consist events (e.g., pickups, crew changes, engine destinations) with planned train activities that occupy track resources for the duration of a dwell time, so that maintenance of the traditional train sheet data (via electronic messaging and user data entry) is automatically reflected in the train trip specifications for use for movement planning.

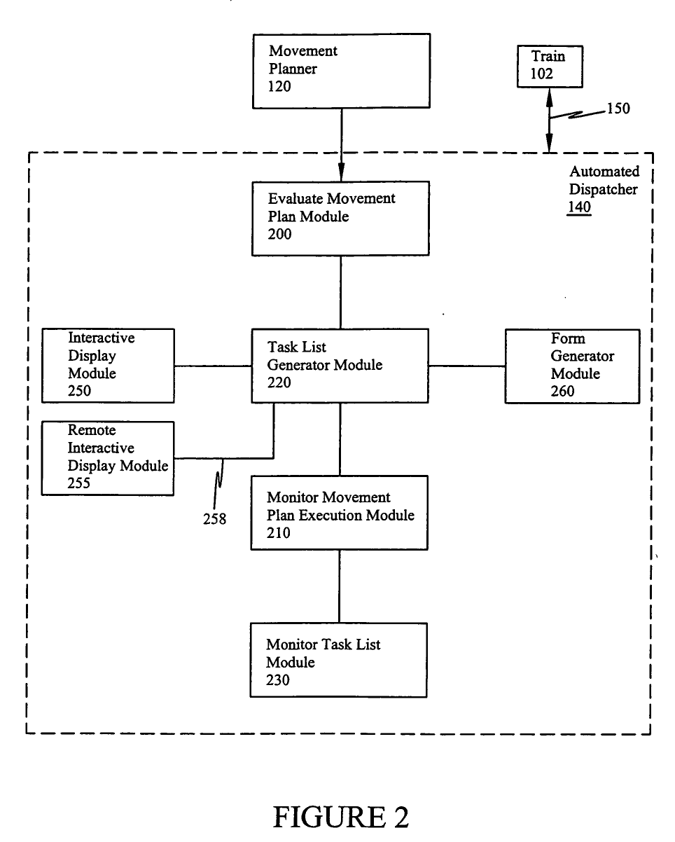

As reflected in FIG. 2, the movement plan provided by movement planner 120 may be evaluated by the automated dispatcher 140 in the evaluate movement plan module 200. The evaluate movement plan module can predict the expected occurrence of events based suitable factors such as historical train performance, local movement train characteristics, the track database, topology database, crew information, operating rules and guidelines and weather information. The automated dispatcher can generate a task list identifying specific actions to be taken by the dispatcher in the task list generator module 220.

The task list generator module 220 provides the task list to the dispatcher through interactive display module 250. The task list generator module 220 can prompt the dispatcher to take a desired action, request information, provided appropriate forms and assist the dispatcher in other required duties. The occurrence of the predicted events may be monitored in the monitor movement plan execution module 210, and the dispatcher may be prompted to take additional specific actions in response to the occurrence predicted events in task list generator module 220. Any action taken by the dispatcher at interactive display module 250 can be provided to movement planner 120 to take into account in the next movement plan generation cycle.

The dispatcher can be provided with a dynamic task list at interactive display module 250 that not only specifies the tasks to be performed by the dispatcher, but also automatically links the dispatcher display to the form generator module 260.

As disclosed in the referenced applications, the dynamic task list can populate the data input form with information known at the time it is generated. An interactive display may also facilitate communications between the dispatcher and the trains and other resources via communications link 150. The interactive display module 250 may allow the yard manager less access than that of the display module for the dispatcher, but allow the yard manger to provide information relating to the movement of the trains in the yard which may impact the movement plan. The remote interactive display module 255 may also provide the yard manager with a means to specify the arrival and departure tracks for specific trains and to specify the departure order and departure time of trains.

In addition, the interactive display modules 250 and 255 may also facilitate planning by allowing the reservation of resources for the future. Typically, the use of resources and the issuance of movement authorities were done on an ad hoc basis, the movement authorities were issued when needed and not planned in advance. By providing the movement planner with information in advance of its requirement, the movement planner may be have more options available to it to facilitate the utilization of a resource. For example, a yard manager may request a movement of local industry train authority for the future, and the advance planning of such a request makes it less likely that ad hoc dispatcher interaction would be required.

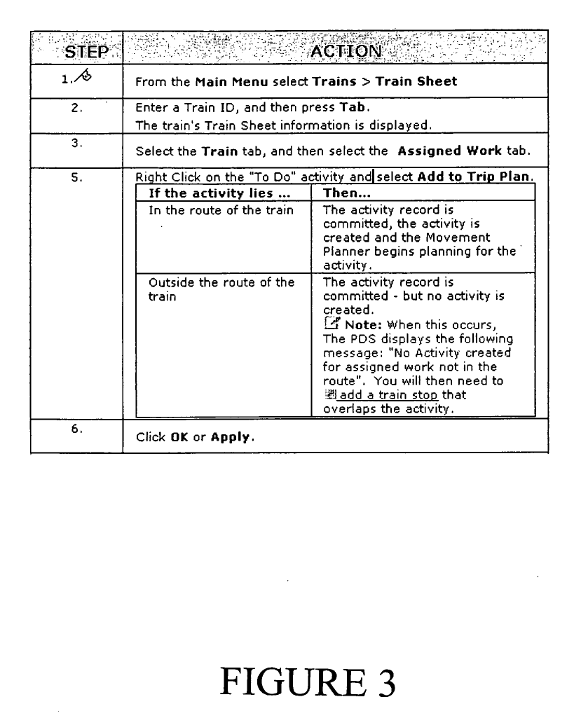

FIG. 3 illustrates one embodiment of a screen by which the dispatcher transfers unscheduled assigned activities to the movement planner. For example, the dispatcher may select a specific train and view the work tab. The work tab may contain the same information as the task list described above. The assigned work tab includes all work that is “assigned” to the train. Assigned work is work that has been planned using the movement planner. The work tab also includes work that is unassigned. Unassigned work is work that has been requested of the train to the dispatcher. The work request may be received via radio to the dispatcher, who must then manually enter it into the dispatching system, or it may be received electronically into the dispatching system. Unassigned work may be considered the ”to do” list for the dispatcher for the train. The dispatcher has the ability to select an “unassigned” task and assign it to the train. By assigning it to the train, the task is transmitted to the movement planner for inclusion in the next planning cycle. Once the activity is planned, the dispatching system is notified by the movement planner and the activity is now indicated to be “assigned” in the work tab.

In another embodiment, the dispatcher may select one or more unassigned tasks for a train and request the movement planner to provide feedback as to the feasibility of the train to perform the unassigned tasks. Thus the present applications allow the dispatcher to propose “what if” scenarios to the movement planner to assist the dispatcher in determining the selection of unassigned tasks for a train to perform.

This method of assigning tasks and planning the local movement of trains can be implemented using computer usable medium having a computer readable code executed by special purpose or general purpose computers.

As is readily apparent, the system and method of the present invention is advantageous in several aspects. While preferred embodiments of the present invention have been described, it is understood that the embodiments described are illustrative only and the scope of the invention is to be defined solely by the appended claims when accorded a full range of equivalence, many variations and modifications naturally occurring to those of skill in the art from a perusal hereof.

What is claimed is:

1. A method of scheduling the sporadic use of the main railway track of a railway network to local trains in which one or more multiple car throughway trains are moved along the main railway track under control of a dispatcher assisted by a scheduling computer prepared plan, comprising:
(a) electronically receiving a request for a work order for a local train to use the main railway track in a dispatching computer;
(b) displaying the work request as an unassigned work request for the dispatcher;
(c) selecting the displayed unassigned work request to be performed by a selected local train;
(d) electronic sending the selected work request for the selected local train to the scheduling computer;
(e) planning the movement of the local train in the scheduling computer; and
(f) electronically communicating to the dispatching computer that the work request has been planned for the selected train.

2. The method of claim 1 further comprising the step of displaying the planned work request in the dispatching computer.

3. A method of assisting a train dispatcher, who receives an order for movement of local industry trains requiring that the dispatcher provide access a main railway track from time to time, in controlling the interaction of the movement of the local industry train along the main railway track with the computer planned movement of a throughway train, said method comprising the steps of:
(a) using a scheduling computer to prepare a plan for the movement of plurality of multiple car throughway trains along a main railway track;
(b) receiving a work request for movement of a local industry train along the main railway track;
(c) inserting into the scheduling computer the work request for the then unscheduled movement of a specific local industry train along the main railway track; and
(d) modifying the computer prepared movement plan to include the movement of the local industry train.

4. The method of claim 3 including the step of displaying to the dispatcher information as to available resources for each of the activities included in the work request for the then unscheduled movement of a local industry train.

5. The method of claim 4 wherein the display of available resources is interactive enabling the dispatcher to request modifications to the movement plan by the act of assigning resources to the activities.

6. In a railroad system in which one or more multiple car throughway trains are moved along a main railway track under control of a dispatcher assisted by a scheduling computer prepared plan that receives work orders for activities to be performed by assigned resources, assigns time intervals to every activity, and assigns available resources to scheduled activities, and
where a dispatcher receives an order for movement of a local industry train requiring access to the main railway track,
the improvement wherein the movement of the local industry train is integrated into the plan by the scheduling computer rather than manually scheduled by the dispatcher so as not to interfere with the scheduled movement of throughway trains.
